(19) United States
(12) Patent Application Publication
(10) Pub. No.: US 2022/0307434 A1
(43) Pub. Date: Sep. 29, 2022

(54) DECELERATION MANAGEMENT FOR DYNAMIC SKIP FIRE

(71) Applicants: Tula Technology, Inc., San Jose, CA (US); Cummins, Inc., Columbus, IN (US)

(72) Inventors: Louis J. Serrano, Los Gatos, CA (US); Kevin Shikui Chen, San Jose, CA (US); Xiaoping Cai, Fremont, CA (US); John Fuerst, Chicago, IL (US)

(73) Assignees: Tula Technology, Inc., San Jose, CA (US); Cummins, Inc., Columbus, IN (US)

(21) Appl. No.: 17/213,387

(22) Filed: Mar. 26, 2021

(51) Int. Cl. F02D 41/00; B60W 20/15; B60W 10/06; B60W 10/08; B60W 30/18; F02D 41/12; F02D 41/02

(52) U.S. Cl. CPC F02D 41/008; B60W 20/15; B60W 10/06; B60W 10/08; B60W 30/18136; F02D 41/12; F02D 41/024; B60W 2510/244

(57) ABSTRACT

A variety of methods and arrangements are described for operating an engine in a skip fire manner so that engine requirements, such as exhaust temperature, exhaust flow, torque and NVH, are met.

### FIELD OF THE INVENTION

This present invention relates generally to operating an engine in a skip fire manner so that engine requirements, such as exhaust temperature, exhaust flow, torque and NVH, are met.

### BACKGROUND OF THE INVENTION

Fuel efficiency of many types of internal combustion engines can be improved by varying the displacement of the engine. This allows for the use of full displacement when full torque is required and the use of smaller displacements when full torque is not required. Engines that use standard cylinder deactivation (CDA) reduce engine displacement by deactivating subsets of cylinders. For example, an eight-cylinder engine can reduce its displacement by half by deactivating four cylinders. Likewise, a four-cylinder engine can reduce its displacement by half by deactivating two cylinders, or a six-cylinder engine can reduce its displacement to ⅓ by deactivating four cylinders. In all of these cases, the deactivated (i.e., skipped) cylinders do not fire while the engine is operated at this reduced level of displacement. The firing patterns that arise in CDA are called fixed patterns, because the cylinders which skip are fixed during the entire time the engine is at that level of reduced displacement.

In contrast, engines that use skip-fire control can reduce engine displacement to other levels by deactivating one or more cylinders for one cycle, then firing these cylinders the next cycle, then skipping or firing them on a third cycle. In this method, for example, an eight-cylinder or four-cylinder engine can reduce its displacement to ⅓ by having each cylinder repeatedly skip, then fire, then skip. This reduction in engine displacement cannot be attained simply by deactivating a subset of cylinders. Certain firing patterns that arise in skip-fire operation are called rolling patterns, because the cylinders that deactivate change, each cycle causing the pattern of skips and fires to roll across the cylinders over time. In other words, a first engine cycle may have a first set of cylinders fired and a second engine cycle may have a different second set of cylinders fired while the engine remains at the same displacement level. An engine cycle is generally defined as the time required for all cylinders to complete the four distinct piston strokes (intake, compression, power/expansion, and exhaust), which generally requires two (2) rotations of the crankshaft (720 degrees) for a 4-stroke engine commonly used to supply motive power to a vehicle.

After-treatment systems have been used with internal combustion engines to control exhaust emissions. In order to operate properly, the after-treatment system must be heated to an appropriate temperature. Otherwise, an engine, such as a diesel engine, can generate too much NOx. When the engine operates at lighter loads, for example, during deceleration, the exhaust gases can be cool enough to reduce the efficiency of the after-treatment system. To prevent this from occurring, during low load conditions, some cylinders can be deactivated, which decreases the amount of exhaust, thus improving the temperature of the after-treatment system. However, if exhaust flow stays low for too long, the turbo speed will drop to an unacceptable level. Compression release braking (CRB) can be used to increase and heat the exhaust flow, but this causes engine braking. This unwanted engine braking can be counteracted by generating extra torque by firing cylinders.

When an engine receives a request for zero or negative torque, the engine can operate in a deceleration cylinder cut-off mode (DCCO), in which fuel is not injected into the cylinders and the intake and exhaust valves are not operated (i.e., deactivated), or a skip-cylinder engine braking mode, in which selected working chambers operate in a compression release braking mode. A description of DCCO and skip-cylinder engine braking mode are presented in U.S. 2020/0318565 and U.S. 2020/0318566, which are hereby incorporated by reference in their entireties. However, when the engine operates in DCCO mode, the exhaust flow is eliminated because air is not pumped through the cylinders. As a result, the turbo speed can quickly drop below an acceptable limit.

Alternatively, in order to maintain turbo speed during deceleration, the intake and exhaust valves of the cylinders can be operated such that air is still pumped through the cylinders without injecting fuel into the cylinders. This can be described as deceleration fuel cut-off (DFCO) mode. DFCO mode is more fuel efficient than firing the cylinders, but the exhaust from the cylinders is unheated, which reduces the performance of the after-treatment system. Firing the cylinders can be used to heat the exhaust, but this creates unwanted torque, for example when the vehicle is decelerating.

### SUMMARY

Methods of controlling an internal combustion engine in a skip fire manner are described. In at least one embodiment, the method comprises selecting an induction ratio and firing fraction that generate sufficient exhaust heat, generate a desired torque, generate a desired airflow and use a minimal amount of fuel, and selecting which cylinders to deactivate, which cylinders to fire and which cylinders to operate in a braking mode in order to deliver a desired torque of the engine, a desired exhaust flow of the engine, and a desired exhaust temperature of the engine.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 shows simulation results of running cylinders in different modes during deceleration.

FIG. 2 shows the operation of the electronic control module (ECM) according to at least one embodiment.

FIG. 3 shows how to compute the best IR and FF pair from a list of acceptable pairs according to an embodiment.

FIG. 4 shows how to compute the best IR and FF pair from a list of acceptable pairs according to another embodiment.

FIG. 5 illustrates a circuit that generates a braking and firing flag using sigma delta converters.

FIG. 6 shows a logic table to determine firing and braking flags.

### DETAILED DESCRIPTION

The subject innovation is now described with reference to the drawings, wherein like reference numerals are used to refer to like elements throughout. In the following description, for purposes of explanation, numerals specific details are set forth in order to provide a thorough understanding of the present invention. It may be evident, however, that the present invention may be practiced without these specific details.

Generally, skip fire engine control involves deactivating one or more selected working cycles of one or more working chambers (i.e., cylinders) and firing one or more working cycles of one or more working chambers (i.e., cylinders). When cylinders are deactivated (i.e., skipped), the intake valve and exhaust valve remain closed and fuel injection is stopped. Individual working chambers are sometimes deactivated and sometimes fired. In various skip fire applications, individual working chambers have firing patterns that can change on a firing opportunity by firing opportunity basis by using a sigma delta, or equivalently a delta sigma, converter. Such a skip fire control system may be defined as dynamic skip fire control or “DSF.” For example, an individual working chamber could be skipped during one firing opportunity, fired during the next firing opportunity, and then skipped or fired at the very next firing opportunity. The assignee of the present application has filed many applications involving skip fire engine operation, including U.S. Pat. Nos. 7,954,474; 7,886,715; 7,849,835; 7,577,511; 8,099,224; 8,131,445; 8,131,447; 8,616,181; 8,701,628; 9,086,020; 9,120,478; 9,200,575; 9,200,587; 9,650,971; 9,328,672; 9,239,037; 9,267,454; 9,273,643; 9,664,130; 9,945,313; 9,291,106; and 10,247,121, each of which is incorporated herein by reference in its entirety. Many of the aforementioned applications describe engine controllers, firing fraction calculators, filters, power train parameter adjusting modules, firing timing determination modules, ECUs and other mechanisms that may be incorporated into any of the described embodiments to generate, for example, a suitable firing fraction, skip fire firing sequence or torque output.

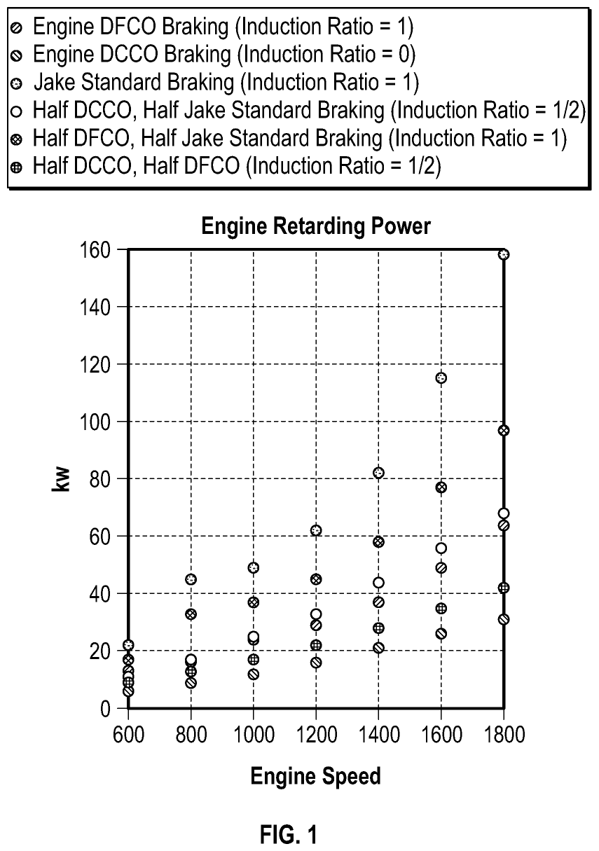

Although conventionally DCCO mode and DFCO mode have referred to the entire engine operating in these modes, in at least one embodiment of the present invention, the engine can be run in a partial DCCO mode in which some cylinders are run in DCCO mode (unfueled and deactivated) and/or a partial DFCO mode (unfueled and pumping) in which some cylinders are run in DFCO mode. A conventional CRB operation operates all of the cylinders in CRB mode in order to increase the engine retarding power to slow down the vehicle, for example when a vehicle is running downhill. When a vehicle is running on a normal road, e.g. deceleration from highway cruising, it may not be necessary to operate all of the cylinders in CRB mode, as the service brake can provide enough braking power to slow down the vehicle. In this situation, some cylinders can be operated in CRB mode, and some cylinders can be operated in DCCO mode. This creates the same engine retarding power as running all of the cylinders in DFCO mode while keeping the exhaust temperature high as well as meeting minimum turbo speed requirements. FIG. 1 shows the results of a simulation of an engine with cylinders running with different deceleration modes. Specifically, FIG. 1 shows the engine retarding power, turbine outlet temperature, turbo speed and charge flow plotted against engine speed for the following deceleration modes: (a) DFCO with an induction ratio of 1; (b) DCCO with an induction ratio of 0; (c) CRB with an induction ratio of 1; (d) half DCCO, half CRB with an induction ratio of 1/2; (e) half DFCO, half CRB with an induction ratio of 1; and (f) half DCCO, half DFCO with an induction ratio of 1/2. As shown in FIG. 1, running half of the cylinders at DCCO and half at CRB (i.e., deceleration mode (d)), creates approximately the same engine retarding/braking power as running all of the cylinders in DFCO mode (i.e., deceleration mode (a)), while also maintaining a high turbine outlet temperature and a high turbo speed. One or more of these deceleration modes could include firing one or more cylinders instead of deactivating it in order to increase engine torque (decrease engine braking) and increase air flow.

Table 1 below shows the relative effects on engine braking power, fuel economy during coasting, exhaust temperature, turbo speed, engine noise and acceleration out of deceleration.

TABLE 1

| | | | | | | Acceleration |
|---|---|---|---|---|---|---|
| | | | | | | out of |
| | | | | | | Deceleration |
| | Engine | Coasting | | | | Torque |
| | Braking | (fuel | Exhaust | Turbo | Engine | Response |
| | Power | economy) | Temp. | Speed | Noise | and Smoke |
| CRB | + | − | ++ | ++ | − | + |
| | | | (create heat) | | | |
| DCCO | − | + | + | − | + | − |
| | | | (keep heat) | | | |
| DFCO | 0 | 0 | − | + | 0 | + |

+ → positive
− → negative
0 → neutral

By taking into account the effects of DCCO, DFCO and CRB on engine performance as outlined above in Table 1, the state of the cylinders can be varied between DCCO, DFCO and CRB to optimize performance. For example, at the start of deceleration, the electronic control module (ECM) or electronic control unit (ECU) (i.e., engine controller) can command all six (6) cylinders (assuming a six-cylinder engine) to operate in the DCCO mode. Since the intake and exhaust valves are deactivated in DCCO mode, this may cause the turbo speed to drop. When the turbo speed drops below a predetermined lower level, such as approximately 1,2000 rpm, the ECM can command some cylinders (e.g., 3 cylinders) to operate in DFCO mode provided that the exhaust temperature is sufficient, for example approximately 200-250 C. A sufficient temperature could be approximately 600 C or more when doing deSOx, or approximately 500 C during de-soot of the particle filter. Alternatively, the ECM can command three (3) cylinders to run in CRB mode. However, this can cause the engine retarding power and noise to begin earlier at higher engine speeds in the early stages of deceleration. The transition of some cylinders to DFCO can be done incrementally one cylinder at a time using decisions from a sigma-delta controller until the turbo speed exceeds the predetermined lower level. As cylinders are switched to DFCO mode, the exhaust temperature can decrease. When the exhaust temperature drops below a predetermined level, the ECM can command some of the DFCO cylinders to operate in CRB mode until the exhaust temperature exceeds the predetermined level. The exhaust temperature can be computed by using a model or by using an actual measurement. The transition of some cylinders to CRB can be done incrementally one cylinder at a time using decisions from a sigma-delta controller until the exhaust temperature exceeds the predetermined level. Operating some cylinders in CRB creates unnecessary engine retarding power. So, once the exhaust temperature exceeds the predetermined level, the ECM can switch the CRB cylinders to DFCO.

Alternatively, mixed fractions of cylinders running in DFCO, DCCO and CRB modes can be done. For example, three (3) cylinders of the six-cylinder engine could be run in DCCO mode and the other three (3) cylinders could be run alternatively in CRB and DFCO modes. This reduces the unnecessary engine retarding power. Additionally, some cylinders can be commanded to burn a precise amount of fuel to increase exhaust temperature, exhaust flow and to generate torque to decrease the amount of engine braking.

As an example, a zero accelerator pedal position (APP) and zero brake pedal position can be calibrated to be −50 Nm of brake torque, which can be delivered by placing all of the cylinders in DCCO mode. However, this will cause the turbo speed to drop quickly. In order to increase the exhaust flow, some cylinders can be commanded to start to run in DFCO mode. However, if the exhaust gas is cooler than desired, some cylinders can be run in CRB mode. In both of these situations, the desired torque can be satisfied by generating torque in at least one additional cylinder.

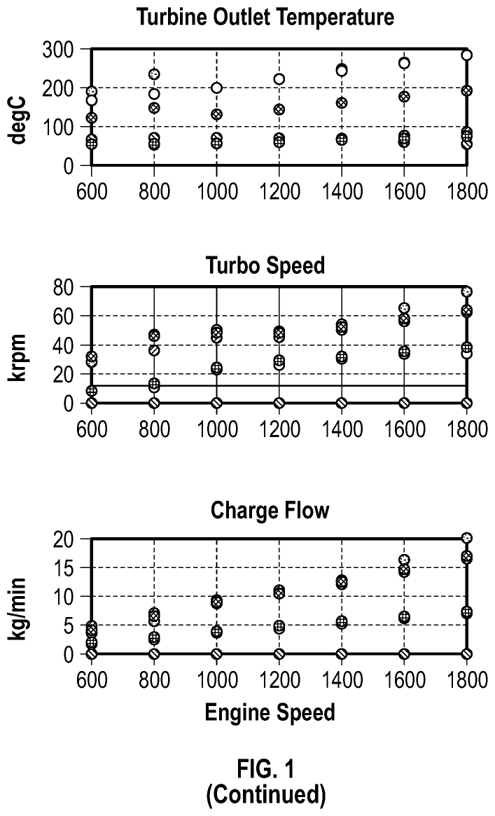

The operation of the ECM as presented above can be demonstrated with the flow chart shown in FIG. 2. As shown in FIG. 2, an initial starting point is selected, such as a firing fraction of ⅓ with ⅔ of the cylinders in DCCO mode. The starting point could be a default starting point programmed at the factory. Then, the fraction of cylinders in DFCO, DCCO, CRB and fueling are selected to meet torque, air flow and exhaust temperature requirements. During operation of the flow chart shown in FIG. 2, the current status of each cylinder should be tracked.

At least one embodiment of the present invention selects a firing fraction (FF), an induction ratio (IR) and fuel amount per cylinder to create a desired deceleration torque, a desired air flow (for the turbocharger) and a desired exhaust temperature. The IR generally is understood to be the fraction of cylinder events that induct air from the intake manifold and pump the air to the exhaust manifold (i.e., not skipped). The FF is generally understood to be the fraction of induction events that are fueled and fired. Both values range from 0 to 1. The value of IR to create the desired air flow can be determined from the required flow to create the desired turbo speed, as shown in Equation (1) below.

IR×Engine_Air_Flow>=Desired_Air_Flow Equation (1)

The firing fraction can be determined by the requirement that the combination of braking and firing meet the torque request. As shown in Equation (2) below, BTq is the braking torque when all cylinders operate in CRB mode and FTq is the torque created when all cylinders fire using fpc fuel.

FTq(fpc)×IR×FF+BTq×IR(1−FF)=Torque Request Equation(2)

Next, the exhaust requirement needs to be met, as shown below in Equation (3). FHeat is the heat generated by the engine when the fuel per cylinder (fpc) is combusted in all of the cylinders and BHeat is the heat generated by the engine in CRB mode.

FHeat(fpc)×FF×IR+BHeat×IRx(1−FF)=Exhaust Heat Equation(3)

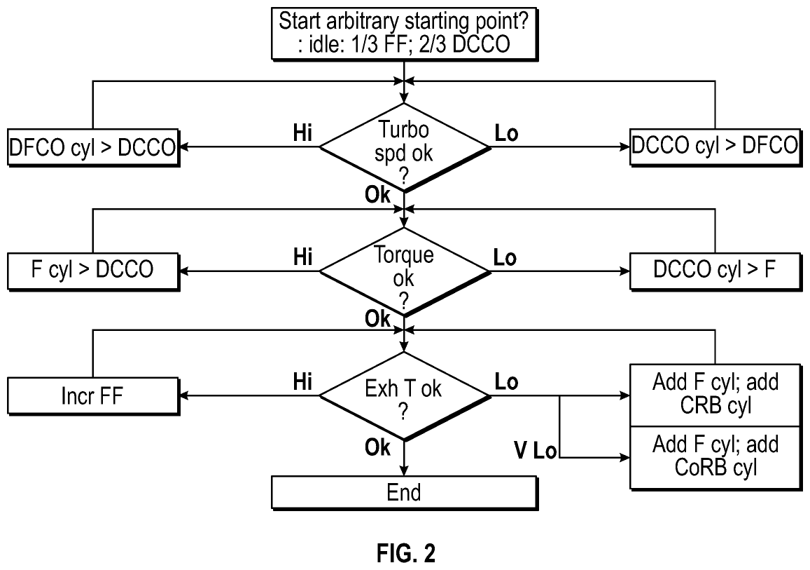

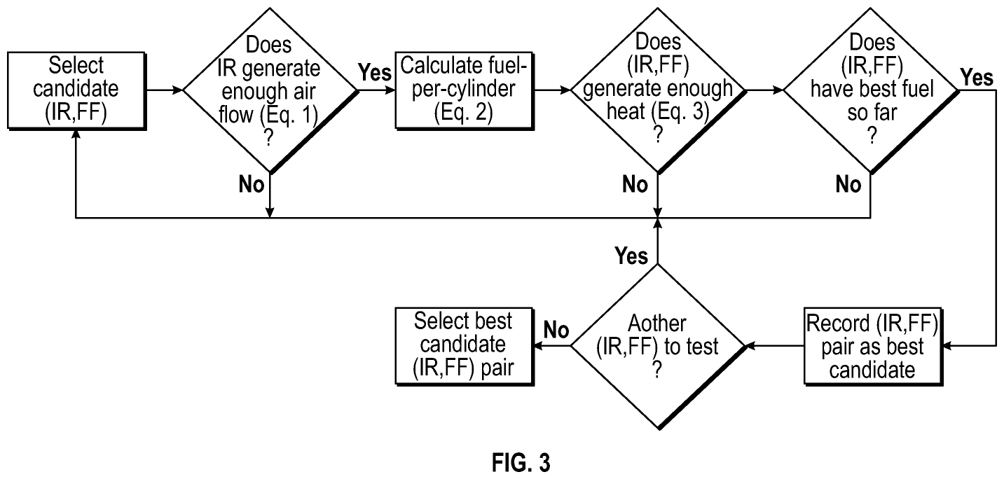

FIG. 3 shows how to compute the best IR and FF pair from a list of acceptable pairs. The selected pair will generate sufficient heat, sufficient airflow, sufficient torque and use the least fuel of the pairs. The input to FIG. 3 is a list of IR/FF candidate pairs that can be tested to see if they satisfy the desired deceleration torque, air flow and exhaust temperature. Other criteria can be used, such as noise, vibration and harshness (NVH), as shown in FIG. 4. If a given IR/FF pair causes unacceptable NVH, then that pair can be excluded. The Firing Fraction can also be called a Firing Ratio. The best IR and FF pair also could be selected from a look-up table or a predefined collection of pairs. A sample look-up table is shown below.

TABLE 2
Braking torque limit that each [IR, FF] can produce before dia-allowed for NVH reasons

| | | Engine Speed | | | | | | | | | | | | |
|---|---|---|---|---|---|---|---|---|---|---|---|---|---|---|
| | | 1000 | 1100 | 1200 | 1300 | 1400 | 1500 | 1600 | 1700 | 1800 | 1900 | 2000 | 2100 | 2200 |
| (IR, FF) | [1/ [symbol] , 0] | 0 | 0 | 0 | 0 | 0 | 0 | 0 | 0 | [symbol] 0 | [symbol] | 20 | 20 | 30 |
| [symbol] | [1/ [symbol] , 1/ [symbol] ] | 0 | 0 | 0 | 0 | 0 | 0 | [symbol] | 1 [symbol] | [symbol] | [symbol] | [symbol] 0 | 34 | 3 [symbol] |
| | [1/ [symbol] , 1] | 0 | 0 | 0 | 0 | 0 | 0 | 0 | 0 | [symbol] 0 | 30 | [symbol] | [symbol] 0 | [symbol] |
| | [1/2, 0] | 0 | 0 | 0 | 0 | 0 | 1 [symbol] | 31 | 3 [symbol] | 3 [symbol] | 3 [symbol] | 32 | 32 | [symbol] |
| | [1/ [symbol] , 1/4] | 0 | 0 | 0 | 0 | 0 | 0 | 0 | 0 | 0 | 0 | 0 | 0 | 0 |
| | [1/2, 1/2] | 0 | 0 | 0 | 17 | 34 | 34 | 34 | 35 | 3 [symbol] | 3 [symbol] | 40 | 40 | 40 |
| | [1/2, 1] | 0 | 15 | 30 | 3 [symbol] | 34 | 42 | 4 [symbol] | [symbol] | [symbol] | 32 | [symbol] 2 | [symbol] 3 | [symbol] |
| | [ [symbol] /3, 0] | 0 | 0 | 0 | 0 | 0 | 0 | 0 | 0 | 0 | 0 | 0 | 0 | 0 |
| | [ [symbol] /3, 1/4] | 0 | 19 | [symbol] | 47 | [symbol] | [symbol] 3 | 71 | 7 [symbol] | 70 | 70 | 71 | 74 | 77 |
| | [2/3, 1/2] | 0 | 0 | 0 | 0 | 0 | 0 | 0 | 0 | 0 | 0 | 0 | 0 | 0 |
| | [2/3, 3/4] | 0 | 0 | 0 | [symbol] | [symbol] | [symbol] 8 | [symbol] | [symbol] 2 | 83 | [symbol] | [symbol] | 84 | [symbol] 4 |
| | [2/3, 1] | 0 | 2 [symbol] | 70 | [symbol] | [symbol] | 7 [symbol] | [symbol] | 8 [symbol] | [symbol] | [symbol] | [symbol] | [symbol] | [symbol] 1 |
| | [3/4, 0] | 0 | 0 | 0 | 0 | 0 | 0 | 0 | 0 | 0 | 0 | 0 | 0 | 0 |
| | [ [symbol] /4, 1/3] | 0 | 30 | [symbol] 0 | [symbol] | 71 | 80 | [symbol] | [symbol] | [symbol] | [symbol] 4 | 100 | 100 | 100 |
| | [3/4, 3/ [symbol] ] | 0 | 30 | [symbol] 0 | [symbol] | 71 | 7 [symbol] | 80 | [symbol] | [symbol] | [symbol] 7 | 100 | 100 | 100 |
| | [1, 0] | [symbol] | 2 [symbol] | 2 [symbol] | [symbol] | 2 [symbol] | 2 [symbol] | [symbol] | 2 [symbol] | 2 [symbol] | [symbol] | [symbol] | 2 [symbol] | 2 [symbol] |
| | [1, 1/3] | 100 | 111 | 13 [symbol] | 124 | 12 [symbol] | 13 [symbol] | 14 [symbol] | 14 [symbol] | 145 | 14 [symbol] | 14 [symbol] | 145 | 14 [symbol] |
| | [1, [symbol] ] | [symbol] | 286 | 2 [symbol] | [symbol] | 286 | 23 [symbol] | [symbol] | [symbol] | 2 [symbol] | [symbol] | [symbol] | [symbol] | [symbol] |

[symbol]

indicates data missing or illegible when filed

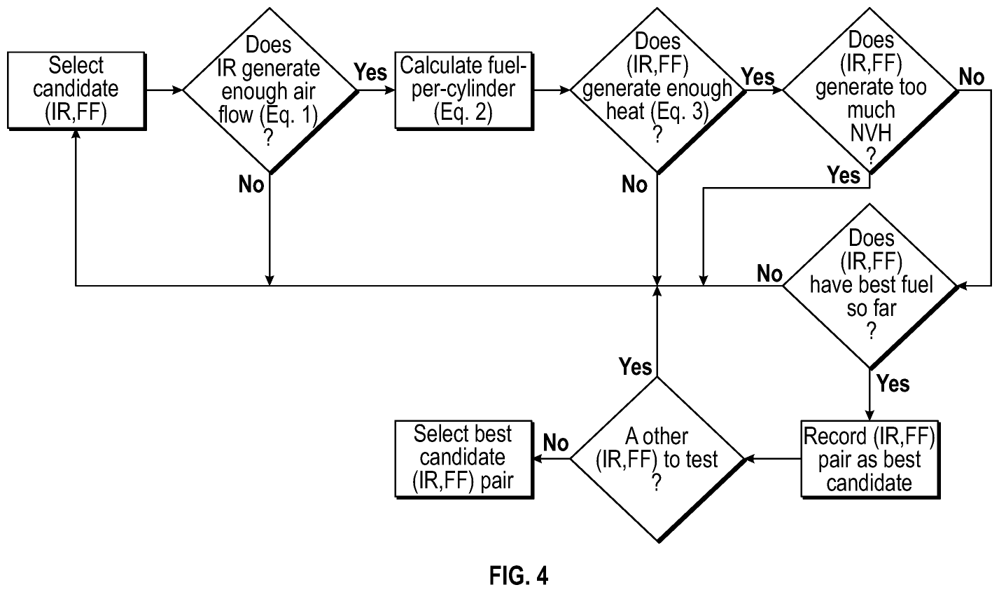

Once we have the selected IR/FF pair, as computed by FIG. 3 and FIG. 4, the multi-level skip fire sequence of the cylinders can be determined (i.e., skip, fire, brake, etc.), as shown in FIG. 5 and as described below. That is, by selectively firing, braking, and skipping various cylinders, a desired amount of torque can be generated with sufficient exhaust temperature, sufficient turbo speed and acceptable NVH while minimizing fuel consumption.

FIG. 5 illustrates a circuit 2000 that uses sigma delta converters which can be part of a firing timing determination module, as shown in U.S. Pat. No. 9,399,964, which is hereby incorporated by reference in its entirety. In this embodiment, the firing timing determination module inputs the induction ratio (IR) and the firing ratio obtained from the algorithms shown in FIGS. 4 and 5 into the sigma delta circuit 2000 of FIG. 5 in order to generate a suitable multi-level skip fire firing sequence. The circuit 2000 may be implemented in hardware or software (e.g., as part of a software module or implementation in executable computer code). In the figure, the symbol 1/z indicates a delay.

The top portion of the circuit 2000 effectively implements a first order sigma delta algorithm. In the circuit 2000, the induction ratio (IR) is provided at input 2002. At subtracter 2004, the induction ratio 2002 and feedback 2006 are added. The sum 2008 is passed to an accumulator 2010. The accumulator 2010 adds the sum 2008 with feedback 2014 to generate sum 2012. Sum 2012 is fed back into the accumulator 2010 as feedback 2014. Sum 2012 is passed to a quantizer 2018 and converted into a binary stream. That is, the quantizer 2018 generates induction decision 2020, which forms a sequence of 0's and 1's. Each 0 indicates that an associated working chamber should be skipped. Each 1 indicates that an associated working chamber should be inducted. The induction value is converted to a floating number at converter 2019 to generate value 2022, which is inputted into the subtracter 2004 as feedback 2006.

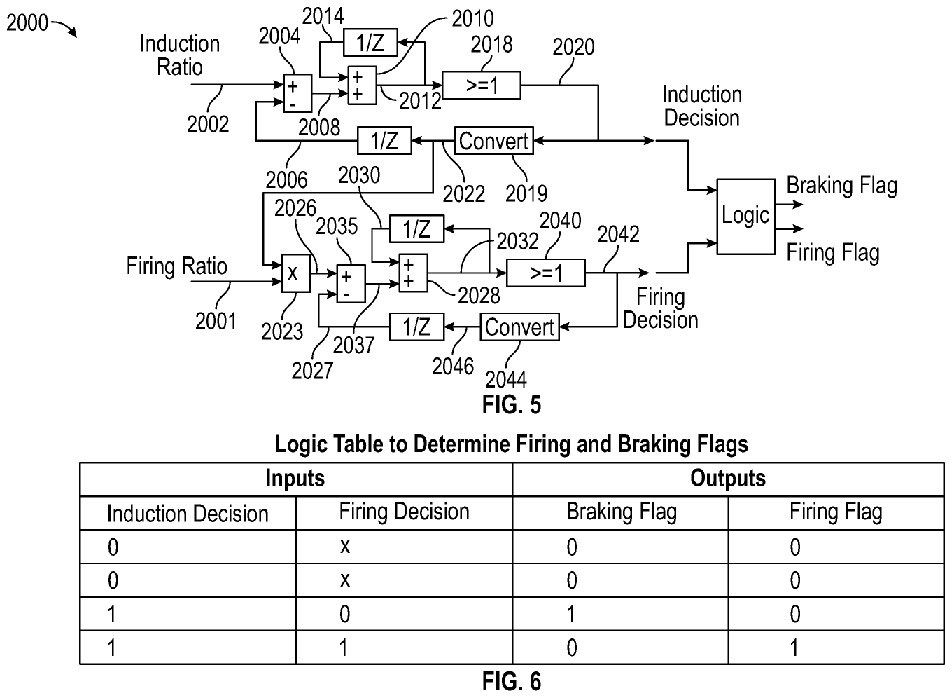

The bottom portion of the circuit indicates, for each induction indicated by induction decision 2020, whether the cylinder should fire or brake to deliver the desired torque. Value 2022 is passed to a multiplier 2023, which also receives the firing ratio 2001. The multiplier 2023 multiplies these two inputs. Thus, if a skip was indicated at value 2022, this causes the output of the multiplier 2023 to be 0. The above multiplication results in a value 2026, which is passed to a subtracter 2035. The subtracter 2035 subtracts feedback 2027 from the value 2026. The resulting value 2037 is passed to the accumulator 2028. The accumulator 2028 adds the value 2037 to the feedback 2030. The resulting value 2032 is fed back to the accumulator 2028 as feedback 2030 and is also passed to the quantizer 2040. The quantizer 2040 converts the input to a binary value i.e., 0 or 1. (For example, if the input value 2032 is >=1, then the output of the quantizer is 1. Otherwise, the output is 0.) The resulting firing decision 2042 and induction decision 2020 are fed to the Logic Table shown in FIG. 6 to determine firing and braking flags. The firing decision 2042 is passed to a converter 2044, which converts the value to a floating number. The resulting number 2046 is passed to the subtracter 2035 as feedback 2027.

The above circuit thus provides a multi-level skip fire firing sequence that can be used to operate the engine. In this example, based on the induction ratio (IR) (e.g., as determined in FIG. 4 or 5), the induction decision 2020 is generated. Based on the firing ratio, a firing decision is generated. The resulting induction decision and firing decision are fed to the Logic Table shown in FIG. 6 to determine firing and braking flags.

The circuit shown in FIG. 5, the flowcharts and logic tables disclosed herein and all other methods and functions disclosed herein can be performed by an engine controller or by instructions recorded on a non-transitory, computer-readable medium. The term “non-transitory computer-readable medium” can include a single medium or multiple media that store instructions, and can include any mechanism that stores information in a form readable by a computer, such as read-only memory (ROM), random-access memory (RAM), erasable programmable memory (EPROM and EEPROM), or flash memory.

The present invention also can be used in a hybrid electric vehicle that is powered by an internal combustion engine and an electric motor. Equation (2) above can still be used, but the torque request is adjusted to include the torque produced or consumed by the motor generating torque (MGU). As presented above, CRB can be used to generate heat. But, this creates unwanted negative torque. The MGU can be used to counteract this negative torque created in CRB mode. This may be preferable to using the battery to heat the after-treatment system, as no heating elements are required. For some hybrid dDSF operations with no minimum turbo speed requirements, it is possible to run DCCO during deceleration. If extra braking power is required, it can be provided by battery regeneration. This makes it possible to reduce the use of CRB, which can be prohibited in some urban areas due to the noise ordinances. However, if the state-of-charge of the battery (SOC) reaches full, then CRB can be used instead of battery regeneration. Also, if hotter exhaust is desired, braking can be done with CRB instead of battery regeneration.

In a hybrid engine, the amount of positive or negative torque to be generated by the MGU must be calculated. This can be accomplished by modeling, estimating or measuring the catalyst temperature and the SOC of the battery. Using the modeled catalyst temperature and the state-of-charge of the battery, whether the MGU generates torque can be determined using the logic shown in Table 3. It is assumed that NOx reduction takes precedence over CO2 reduction.

TABLE 3

| | Cat T < threshold | Cat T > threshold |
|---|---|---|
| SOC < threshold | Zero | Negative |
| SOC > threshold | Positive | Zero |

A typical threshold for the catalyst temperature can be approximately 200 C. A typical threshold for the state-of-charge to generate negative torque (i.e., charge the battery) can be approximately 40%. A typical threshold for the state-of-charge to generate positive torque (i.e., discharge the battery) can be approximately 60%. These thresholds can change if, for example, deSOx is required. The torque request to the engine is adjusted by the torque produced or consumed by the MGU. So, if the catalyst is too cold and the battery is mostly charged (lower left corner of Table 3), more MGU torque would be used to overcome engine braking. If the catalyst is warm enough, and the SOC is high (lower right corner of Table 3), the MGU is not used, as additional braking to heat the cat will not be required.

Another embodiment is directed to regenerating an after-treatment catalyst. This can be done by decomposing the sulfates on the catalyst with lean exhaust mixture at a high temperature, a process called deSOx. Diesel exhaust after-treatment systems typically includes a lean NOx trap, also known as a NOx Adsorber, or an SCR catalyst, both of which are sensitive to sulfur poisoning which can deteriorate NOx conversion efficiency. Therefore, a deSOx process is needed periodically to “regenerate” these catalysts by decomposing the sulfates on the catalyst with lean exhaust mixture at high temperature.

During a deSOx event, it is required to raise exhaust gas temperature at catalyst inlet to a desired range, such as 600 to 700° C. Typically, this is achieved by hydrocarbon injection into exhaust upstream of DOC (Diesel Oxidation Catalyst) or in-cylinder late post injection of fuel to generate unburned hydrocarbons which is then converted into heat in the DOC to provide the desired temperature. These methods present several disadvantages compared to using cylinder deactivation or the combination cylinder deactivation with post injection, such as: (1) they require DOC to be sufficiently warm to convert hydrocarbons efficiently; (2) the level of heat generated may be limited by amount of excess oxygen available in the exhaust; and (3) there may be issues with fuel dilution in engine oil due to late post injection (for in-cylinder post injection method) or additional hardware and warranty costs (for Exhaust HC injection method; and (4) It will incur high fuel consumption penalty.

Further, for hydrocarbon injection, an additional fuel injector, fuel pump and plumbing to run fuel line from fuel tank to injector may be needed. This will increase not only costs for those additional components, but also the cost of providing warranty for years to come. For in-cylinder post injection, because of large amount of additional fueling are typically needed to achieve the needed temperature range, it becomes necessary to inject the fuel very late in the combustion stroke. Otherwise, too much torque may be produced from partial burning of the injected fuel. This very-late-injected fuel may impinge on cylinder walls and mixed with lubrication oil on the walls and subsequently ends up in the engine lubrication oil degrading its lubricating performance.

DSF can be used to high enough temperature and desired exhaust composition for deSOx. Under some speed/load operating conditions, DSF alone can be used. Also, a combination of DSF and late post injection can be used when the temperature and/or other conditions, such as exhaust composition, cannot be achieved by using DSF alone. By using DSF, a deSOx, event can be extended to light load operation, which makes it possible to perform deSOx process with normal driving, instead of being asked to operate vehicle in a special way or removing catalyst from vehicle to be regenerated off-line.

To implement this in an engine controller, when a deSOx event is initiated, the firing density determination module can be notified. Based on torque requested, engine speed, desired exhaust temperature and other parameters, an FD determination module can then determine firing density and amount of post injection quantity needed. The module will perform optimization to minimize the use of post injection to minimize fuel consumption penalty. It may be necessary for the FD Determination module to utilize different optimization process from the base DSF operation in determining firing.

It should be understood that the invention is not limited by the specific embodiments described herein, which are offered by way of example and not by way of limitation. Variations and modifications of the above-described embodiments and its various aspects will be apparent to one skilled in the art and fall within the scope of the invention, as set forth in the following claims.

What is claimed is:

1. A method of controlling an internal combustion engine in a skip fire manner, wherein the combustion engine comprises a plurality of working chambers, and each working chamber includes at least one intake valve, and at least one exhaust valve, the method comprising:
selecting an induction ratio and firing fraction that: generate sufficient exhaust heat; generate a desired torque; generate a desired airflow; and use a minimal amount of fuel; and
selecting which cylinders to deactivate, which cylinders to fire, which cylinders to pump and which cylinders to operate in a braking mode in order to deliver a desired torque of the engine, a desired exhaust flow of the engine, and a desired exhaust temperature of the engine.

2. The method according to claim 1, wherein the selected induction ratio and firing fraction also produces an acceptable level of noise, vibration and harshness.

3. The method according to claim 1, wherein deactivating some of the working chambers comprises operating selected working chambers in a deceleration cylinder cut-off mode, and operating some of the working chambers in a braking mode comprises operating selected working chambers in a compression release braking mode.

4. The method according to claim 1, wherein pumping some of the working chambers comprises operating selected working chambers in a deceleration fuel cut-off mode.

5. A method of controlling a vehicle comprising an internal combustion engine, an electric motor for driving the vehicle, and a battery for driving the electric motor, wherein the combustion engine comprises a plurality of working chambers, and each working chamber includes at least one intake valve, and at least one exhaust valve, the method comprising:
selecting an induction ratio and firing fraction that: generates sufficient exhaust heat; generates a desired torque; generates a desired airflow; and uses a minimal amount of fuel;
operating the internal combustion engine in a skip fire manner;
selecting which cylinders to deactivate, which cylinders to fire, which cylinders to pump and which cylinders to operate in a braking mode in order to deliver a desired torque, a desired exhaust flow, and a desired exhaust temperature; and
adjusting the delivered torque by a torque produced/consumed by the electric motor.

6. The method according to claim 5, wherein the selected induction ratio and firing fraction also produces an acceptable level of noise, vibration and harshness.

7. The method according to claim 5, further including adjusting the torque produced/consumed by the electric motor based upon a catalyst temperature and a state-of-charge of the battery.

8. The method according to claim 5, further including using torque assist from the electric motor to reduce retarding power created in braking mode.

9. The method according to claim 5, further including using battery regeneration to provide extra braking power.

10. The method according to claim 9, further including switching from battery regeneration to braking mode when the state of charge of the battery exceeds a threshold.

11. An engine controller in an internal combustion engine operated in a skip fire manner, wherein the combustion engine comprises a plurality of working chambers, and each working chamber includes at least one intake valve, and at least one exhaust valve, the engine controller configured to:
select an induction ratio and firing fraction that: generate sufficient exhaust heat; generate a desired torque; generate a desired airflow; and use a minimal amount of fuel; and
select which cylinders to deactivate, which cylinders to fire, which cylinders to pump and which cylinders to operate in a braking mode in order to deliver a desired torque of the engine, a desired exhaust flow of the engine, and a desired exhaust temperature of the engine.

12. The engine controller according to claim 11, wherein the selected induction ratio and firing fraction also produces an acceptable level of noise, vibration and harshness.

13. The engine controller according to claim 11, wherein deactivating some of the working chambers comprises operating selected working chambers in a deceleration cylinder cut-off mode, and operating some of the working chambers in a braking mode comprises operating selected working chambers in a compression release braking mode.

14. The engine controller according to claim 11, wherein pumping some of the working chambers comprises operating selected working chambers in a deceleration fuel cut-off mode.

15. A non-transitory, computer-readable medium having instructions recorded thereon which when executed by a processor, cause the processor to:
select an induction ratio and firing fraction of an internal combustion engine comprising a plurality of cylinders, wherein the induction ratio and firing fraction generate sufficient exhaust heat; generate a desired torque; generate a desired airflow; and use a minimal amount of fuel; and
select which cylinders to deactivate, which cylinders to fire, which cylinders to pump and which cylinders to operate in a braking mode in order to deliver a desired torque of the engine, a desired exhaust flow of the engine, and a desired exhaust temperature of the engine.

16. The method of clam 1, further including regenerating an after-treatment system by raising the exhaust temperature to a desired range.

17. The method of clam 16, further including using late post injection to achieve desired engine conditions.

18. The method of claim 1, wherein the selecting is done using a circuit that uses a sigma delta converter.
